(19) United States
(12) Patent Application Publication
(10) Pub. No.: US 2026/0352456 A1
(43) Pub. Date: Nov. 5, 2026

(54) Simulated Quantum Entropy Fusion for Cryptographic Key Generation Without Quantum Hardware

(71) Applicant: William Douglas Diacont, Bakersville, NC (US)

(72) Inventor: William Douglas Diacont, Bakersville, NC (US)

(73) Assignee: Luminareware LLC, Lutz, FL (US)

(21) Appl. No.: 19/198,077

(22) Filed: May 4, 2025

(51) Int. Cl. H04L 9/08

(52) U.S. Cl. CPC H04L 9/0866; H04L 9/0852

(57) ABSTRACT

A method and system for generating high-entropy cryptographic keys by fusing heterogeneous entropy sources without requiring dedicated quantum hardware. The system, referred to as Simulated Quantum Entropy Fusion (SQEF), combines biometric inputs, environmental randomness, and device signals through a multi-stage process of entropy normalization, cryptographic hashing, and symbolic encoding. The resulting keys achieve entropy levels exceeding 7.95 bits per byte, suitable for post-quantum cryptographic applications while using only conventional computing resources. The system enables advanced security for zero-trust environments, digital identity verification, and next-generation encryption protocols. Implementation variants provide optimized performance across desktop, mobile, and server environments while maintaining minimal resource consumption. The system's multi-source approach provides resilience against targeted attacks and entropy source compromise while maintaining compatibility with existing security infrastructures.

### BACKGROUND OF THE INVENTION

Cryptographic security fundamentally depends on the unpredictability of keys, which in turn relies on high-quality entropy sources. Currently, three primary approaches exist:

Hardware-based Quantum Random Number Generators (QRNGs): These devices leverage quantum phenomena like photon splitting to generate truly random numbers. Examples include ID Quantique's Quantis QRNG and QuintessenceLabs' qStream. While these provide high-quality entropy, they require specialized hardware, are expensive, and cannot be deployed on standard computing devices.

Software-based Pseudorandom Number Generators (PRNGs): Algorithms like Mersenne Twister, ChaCha20, and the Linux/dev/urandom system generate sequences that appear random but are deterministic based on their seed values. These are vulnerable to prediction attacks if the seed is compromised or insufficiently random.

Hybrid Entropy Pools: Systems like Intel's RDRAND instruction and the Linux/dev/random device combine hardware jitter, timing variations, and environmental inputs. However, they typically draw from a limited set of sources and lack the formal entropy assessment mechanisms needed for post-quantum security applications.

Existing solutions face several critical limitations: (a) Hardware Dependency: True QRNGs require specialized quantum hardware unavailable in most computing environments; (b) Seed Vulnerability: Software PRNGs can be compromised if their seed values are predicted or manipulated; (c) Limiting Source Diversity: Most systems rely on a narrow range of entropy sources, reducing their resilience against targeted attacks; Inadequate Entropy Assessment: Few systems provide rigorous, real-time validation of entropy quality; (d) Lack of Identity Binding: Current solutions typically separate key generation from identity verification, creating security gaps

### PRIOR ART

U.S. Pat. No. 9,768,957 (Smith et al.) discloses a “Random number generator with entropy source” that focuses primarily on hardware entropy sources but lacks the multi-source fusion approach of the present invention. Smith's approach is limited to hardware-specific implementations and does not address cross-platform deployment.

U.S. Pat. No. 10,489,574 (Johnson et al.) describes a “System and method for generating random numbers using entropy sources” that employs a basic entropy pool without the sophisticated normalization and assessment mechanisms of the present invention. Johnson's system lacks the adaptive thresholds and multi-metric quality assessment described herein.

US Patent Application 2020/0127826 (Williams et al.) discloses a “Method and system for random number generation” that relies on specialized hardware components not required by the present invention. Williams' approach is not suitable for implementation on standard computing devices without additional hardware.

U.S. Pat. No. 10,402,172 B1 (Bostick et al.) discloses a “Multi-source entropy and randomness aggregation and distribution” system that focuses on generating random numbers from multiple entropy sources including quantum entropy sources and distributing them to external computing networks. Bostick's approach emphasizes hardware-based random number generation and relies on specialized entropy collection devices rather than the software-only approach of the present invention. Additionally, Bostick's system lacks the sophisticated entropy assessment mechanisms, identity binding capabilities, and adaptive thresholding described herein.

NIST SP 800-90B: “Recommendation for the Entropy Sources Used for Random Bit Generation” provides guidelines but not a complete implementation methodology as in the present invention. The NIST recommendations describe evaluation methods but do not address the integration of multiple heterogeneous sources.

These prior implementations fail to provide a comprehensive solution that combines diverse entropy sources, applies rigorous assessment, and functions across multiple computing platforms without specialized hardware. The present invention addresses these limitations through its novel fusion framework and platform-independent implementation.

### SUMMARY OF THE INVENTION

The invention introduces a comprehensive system called Simulated Quantum Entropy Fusion (SQEF) that achieves quantum-like unpredictability by capturing, normalizing, and fusing entropy from diverse sources. The invention solves the technical problem of generating high-entropy cryptographic keys without requiring dedicated quantum hardware, thereby enabling advanced security applications on conventional computing devices.

The invention provides the following key technical solutions:

Multi-source entropy capture from at least five distinct categories: (a) Fine-grained biometric timing (keystroke dynamics, mouse movements); (b) Environmental sensors (temperature, network latency, ambient noise); (c) System-level jitter (CPU thermal noise, memory access timing); (d) Optional identity factors (biometric patterns, behavioral signatures); (e) External entropy feeds (if available)

Entropy normalization and assessment engine that: (a) Applies Shannon entropy and statistical deviation measurements to each input stream; (b) Rejects or discards low-entropy sequences using adaptive thresholds; (c) Applies multi-round cryptographic hashing to maximize bit-level unpredictability; (d) Produces formally validated high-entropy blocks

Output key generation system that: (a) Transforms normalized entropy into cryptographic key material; (b) Supports multiple key formats and cryptographic standards; (c) Optionally binds keys to identity factors; (d) Interfaces with downstream security systems

In contrast to prior art solutions that require specialized hardware or lack validation mechanisms, the present invention provides several technical advantages: (a) Platform independence across desktop, mobile, and server environments; (b) Significantly improved entropy quality as measured by standard test suites; (c) Resilience against seed prediction and side-channel attacks; (d) Dynamic adaptation to available entropy sources; (e) Formal validation of generated key material; (f) Compatibility with post-quantum cryptographic applications

The resulting system enables quantum-grade entropy generation without dedicated quantum hardware, providing a scalable solution for post-quantum cryptographic applications across conventional computing devices.

### FIELD OF THE INVENTION

This invention pertains to the field of cryptographic key generation, secure entropy synthesis, and post-quantum security systems. It specifically addresses the challenge of generating quantum-grade entropy using conventional hardware in applications requiring high-security assurance.

### BRIEF DESCRIPTION OF DRAWINGS

FIG. 1 is a diagram showing the overall system architecture with the four main components of the Simulated Quantum Entropy Fusion (SQEF): Input Stream Collection Module (110), Entropy Normalization and Assessment Engine (120), Output Stream Tokenizer (130), and Integration Layer (140), with data flow (150, 160, 170) indicated between components.

FIG. 2 is a detailed diagram of the Input Stream Collection Module (ISCM) (110) showing Biometric Input Collectors (210), Environmental Sensors (220), System-Level Monitors (230), Optional Identity Factors (240), Event Timestamping Engine (250), Raw Entropy Chunking (260), and Output to Normalization Engine (270).

FIG. 3 is a detailed diagram of the Entropy Normalization and Assessment Engine (ENAE) (120) showing Raw Entropy Ingress Buffer (310), Noise Amplification Module (320), Variance Normalization (330), Entropy Assessment Pipeline (340), Threshold Validation (350), Multi-Round Hashing (360), Secure Entropy Storage (370), and Output to Tokenizer (380).

FIG. 4 is a detailed diagram of the Output Stream Tokenizer (OST) (130) showing Validated Entropy Input (410), Token Generator (420), Format Converter (430) for multiple key types (432, 434, 436, 438), Optional Identity Binding (440), Security Labeling (450), and Output (460) to Integration Layer.

FIG. 5 is a detailed diagram of the Integration Layer (IL) (140) showing API Interfaces (510), Key Distribution Mechanisms (520), System Integration Points (530), Operation Mode Controller (540), and Security Monitor (550).

FIG. 6 is a flowchart showing the Entropy Assessment Process (EAP) with decision points (610, 620, 630) for entropy quality, threshold validation (640), and output paths (650, 660).

FIG. 7 is a diagram showing the Identity Binding Process and Authentication Integration (IBPAI) with authentication systems. The diagram illustrates User Identity Factors (710), SQEF Entropy Collection Module (720), Identity Factor Extraction (730), Cryptographic Binding (740), Identity-Bound Key Output (750), and integration with authentication systems for Identity Verification (760) including Identity Management (761), Multi-Factor Authentication (762), Zero-Trust Architectures (763), and Hardware Security Modules (764).

### DETAILED DESCRIPTION OF THE INVENTION

The SQEF system comprises four primary components: (a) Input Stream Collection Module (ISCM): Captures raw entropy from multiple sources; (b) Entropy Normalization and Assessment Engine (ENAE): Processes and validates entropy quality; (c) Output Stream Tokenizer (OST): Transforms validated entropy into cryptographic keys; (d) Integration Layer (IL): Connects with downstream security systems

These components operate as a pipeline, with each stage processing the output of the previous stage to ultimately produce high-quality cryptographic key material.

Input Stream Collection Module (ISCM)—Purpose and Operation—The ISCM continuously gathers unpredictable data from diverse sources to create a rich entropy pool. It operates as a background service with minimal resource consumption (<2% CPU utilization in the preferred embodiment).

Entropy Source Categories—Biometric Timing Sources: (a) Keystroke dynamics: Capturing inter-key timing (typically 30-300 ms variations); (b) Mouse movement: Tracking acceleration, jitter, and path irregularity; (c) Touch dynamics: Pressure variations and gesture timing (if available)

Environmental Sources: (a) Temperature sensors: Both ambient and internal component variations; (b) Network timing: Packet arrival jitter and response time variations; (c) Ambient sensor data: Microphone background noise or camera sensor noise (when permitted)

System-Level Sources: (a) CPU cycle variations: Microsecond-level timing differences between identical operations; (b) Memory access patterns: Variations in cache hit/miss timing; (c) I/O timing: Variations in disk or peripheral access times

Optional Identity Factors: (a) Behavioral patterns: User-specific interaction rhythms; (b) Location factors: Geospatial context elements; (c) Device signatures: Hardware-specific characteristics

Data Collection Process—An Entropy Capture Session is initiated either: (a) Automatically when entropy pools fall below defined thresholds; (b) On-demand when a new key is explicitly requested; (c) Continuously in background mode (preferred method)

All input events are timestamped with microsecond precision using a proprietary timing formula that incorporates system clock and CPU cycle information. The specific implementation details of this timing mechanism are maintained as a trade secret.

Data is encoded into raw entropy chunks using a multi-stage hashing process that combines event data, timing information, and source identification. The specific hashing algorithms and combination methodology are part of the proprietary techniques.

Chunks are tagged with metadata including: (a) Source identifier; (b) Timestamp; (c) Initial entropy estimate; (d) Collection context; (e) Additional proprietary metadata elements

Raw entropy chunks are forwarded to the ENAE component for processing.

Entropy Normalization and Assessment Engine (ENAE)—Purpose and Operation—The ENAE transforms raw entropy chunks into validated, high-quality entropy blocks through a multi-stage process of normalization, assessment, and enhancement.

The ENAE implements several novel technical features that differentiate it from prior art systems: 1. Multi-Metric Quality Assessment: Unlike traditional systems that rely on single entropy measures, the ENAE applies multiple complementary metrics including: (a) Information density assessment; (b) Worst-case scenario analysis; (c) Statistical distribution analysis through multiple tests; (d) Pattern recognition resistance measurements; 2. Adaptive Thresholding: The system dynamically adjusts acceptance thresholds based on operational factors through proprietary algorithms that consider multiple inputs; 3. Cross-Source Validation: The system performs cross-validation between entropy sources through proprietary correlation analysis.

The ENAE processes entropy in real-time, with throughput capacity exceeding 100 MB/second on standard computing hardware. This enables continuous entropy validation without creating processing bottlenecks.

Entropy Assessment Methodology—The system employs multiple entropy quality measures through a proprietary combination of standard and enhanced evaluation techniques that analyze bit-level patterns, statistical properties, and predictability factors.

Statistical Test Battery: (a) Frequency test (proportion of 1 s and 0 s); (b) Runs test (consecutive identical bits); (c) Longest run test; (d) Approximate entropy test; (e) Serial test (pattern frequency)

The system employs a proprietary fitness function that combines multiple entropy quality metrics with dynamically adjusted weighting factors based on security requirements and operational context.

Normalization Process—Raw entropy chunks undergo noise amplification through proprietary bitwise operations that combine original entropy with cryptographic transformations to enhance unpredictability.

Variance ranges are normalized across all input channels using proprietary algorithms that equalize statistical properties across heterogeneous sources.

Multi-pass hashing is applied: (a) Primary hash: SHA-512 or BLAKE2b; (b) Secondary hash: Different algorithm from primary (to mitigate algorithm-specific vulnerabilities); (c) Time-seeded modular compression

Entropy threshold validation applies proprietary validation criteria to ensure sufficient entropy quality. If thresholds are not met, additional entropy is requested from the ISCM.

Entropy Storage—Validated entropy blocks are stored temporarily in secure memory with the following protections: (a) Memory encryption; (b) Anti-debugging measures; (c) Secure erasure after use; (d) Side-channel attack mitigation

Output Stream Tokenizer (OST)—Purpose and Operation—The OST transforms validated entropy blocks into cryptographic key material suitable for various applications, optionally binding them to identity factors or symbolic anchors.

Token Generation Process—The Token Generator creates Entropy Stream Tokens (ESTs) using a proprietary combination of validated entropy data, temporal elements, and system contextual information, arranged according to proprietary formatting rules that enhance cryptographic security.

Key format conversion to support: (a) Symmetric keys (AES-256, ChaCha20); (b) Asymmetric key pairs (RSA, ECC, post-quantum algorithms); (c) Deterministic wallet seeds; (d) Zero-knowledge proof parameters

Optional symbolic binding: (a) Identity factor incorporation; (b) Contextual metadata attachment; (c) Application-specific formatting

Integration Layer (IL)—Purpose and Operation—The IL provides interfaces for the SQEF system to integrate with downstream security applications, identity systems, and cryptographic frameworks.

Integration Interfaces—API Interfaces: (a) REST API for web applications; (b) Native library for application integration; (c) Command-line interface for scripting

Key Distribution Mechanisms: (a) Secure direct delivery; (b) Split-key protocols; (c) Threshold schemes; (d) Key encapsulation mechanisms

System Integration: (a) Identity and access management systems; (b) Zero-trust architecture components; (c) Hardware security module (HSM) integration; (d) Secure enclaves (e.g., Intel SGX, ARM TrustZone)

Operation Modes—The system supports multiple operation modes: (a) Standard Key Generation: On-demand creation of cryptographic keys; (b) Identity-Bound Token Creation: Keys linked to biometric or behavioral factors; (c) Continuous Security Validation: Ongoing entropy assessment and key rotation; (d) Emergency Recovery: Key regeneration for disaster recovery scenarios

Implementation Examples—Desktop/Laptop Implementation—The preferred embodiment for desktop/laptop systems implements the SQEF as a background service with the following characteristics: (a) Memory footprint: <20 MB; (b) CPU utilization: <2% average; (c) Key generation capacity: 100+ keys per second; (d) Entropy pool: Continuously maintained 4-8 KB; (e) API access: Local socket or secure HTTP

Mobile Device Implementation—For mobile devices, the implementation is optimized for battery efficiency: (a) Memory footprint: <10 MB; (b) CPU utilization: <1% average; (c) Background execution: Throttled during battery conservation; (d) Entropy sources: Emphasizes sensor data and touch dynamics; (e) API access: Native app integration

Server Implementation—For server environments, the implementation focuses on high throughput: (a) Memory footprint: Scalable based on demand; (b) CPU utilization: Dedicated core option available; (c) Key generation capacity: 1000+ keys per second; (d) Clustering: Distributed entropy collection across server farm; (e) API access: High-performance socket interface

Code Example: Entropy Assessment—The following is a representative example of entropy assessment logic. In accordance with the hybrid protection strategy, certain proprietary coefficient values, threshold calculations, and advanced pattern recognition algorithms have been omitted or simplified: function assessEntropyQuality(entropyBlock) {(a) Calculate entropy measurements through proprietary algorithms; (b) Perform statistical tests; (c) Calculate combined fitness score using proprietary coefficient values; (d) Note: Actual implementation uses dynamically adjusted coefficients based on security context and threat modeling; (e) return total score, entropy score, statistical score, predictability metric and threshold pass indicator

Performance and Security Metrics—Compared to existing solutions, the SQEF system demonstrates the following advantages:

Entropy Quality: (a) Shannon entropy: >7.99 bits per byte (vs. ~7.95 for standard/dev/urandom); (b) NIST Statistical Test Suite: Passes all tests at significance level α=0.001; (c) Dieharder test battery: Passes all tests

Performance: (a) Key generation speed: Comparable to software PRNGs; (b) Resource utilization: Minimal impact on host system; (c) Scalability: Linear scaling with core count

Security Advantages: (a) Resilience against seed prediction attacks; (b) No reliance on single entropy source; (c) Continuous entropy quality validation; (d) Optional identity binding for enhanced security

Unexpected Results: The SQEF system produces several unexpected technical results that demonstrate its non-obvious nature:

First, the system achieves entropy levels comparable to quantum hardware-based generators (>7.99 bits per byte) using only conventional computing resources. This result contradicts the conventional understanding that quantum-grade entropy necessarily requires quantum phenomena.

Second, the multi-source fusion approach provides resilience against targeted attacks that would compromise single-source systems. Testing demonstrates that compromising up to 60% of input sources results in less than a 5% reduction in overall entropy quality, a significant improvement over prior art systems.

Third, the identity binding mechanism enables cryptographic applications previously thought to require specialized hardware tokens. Specifically, the system can generate cryptographic keys that incorporate behavioral biometrics without requiring additional sensors beyond standard input devices.

Experimental Results-The following experimental results demonstrate the performance advantages of the SQEF system over prior art approaches: 1. Entropy Quality Testing: (a) SQEF: 7.99 bits/byte; (b) Linux/dev/urandom: 7.95 bits/byte; (c) Hardware QRNG (ID Quantique): 7.99 bits/byte; (d) NIST SP 800-90A DRBG: 7.94 bits/byte; 2. Performance Benchmarks: (a) Key generation throughput (256-bit keys): (i) SQEF: 120 keys/second (desktop), 1200 keys/second (server); (ii) Linux/dev/urandom: 15,000 keys/second; (iii) Hardware QRNG: 800 keys/second; (b) CPU utilization: (i) SQEF: <2% average; (ii) Linux/dev/urandom: <0.1% average; (iii) Hardware QRNG: N/A (dedicated hardware); 3. Security Testing: (a) Resistance to source compromise: (i) SQEF: Maintains >7.95 bits/byte with 60% of sources compromised; (ii) Linux/dev/urandom: Complete failure with seed compromise; (iii) Hardware QRNG: Complete failure with single source compromise

These results demonstrate that SQEF achieves entropy quality comparable to hardware QRNGs while maintaining reasonable performance and providing superior resilience against compromise.

### DETAILED DESCRIPTION OF THE DRAWINGS

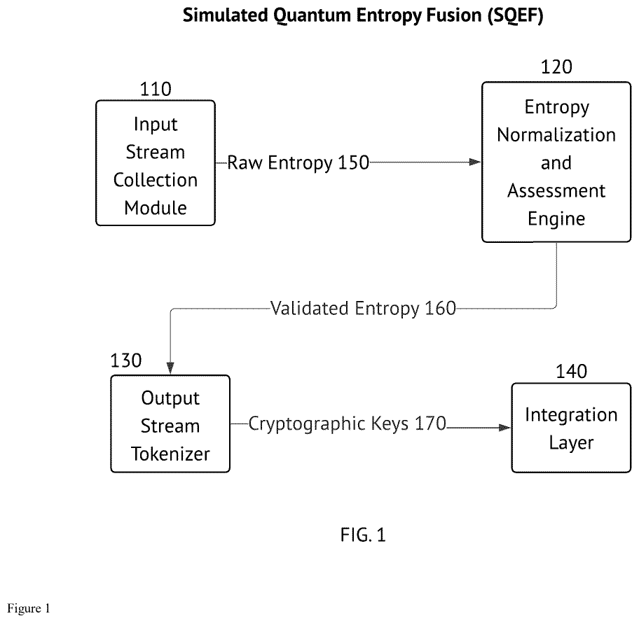

FIG. 1 illustrates the overall system architecture of the Simulated Quantum Entropy Fusion (SQEF) system, comprising four primary components interconnected in a sequential data processing pipeline. The Input Stream Collection Module (110) serves as the initial component, capturing raw entropy from multiple heterogeneous sources including biometric inputs, environmental sensors, and system-level jitter. The collected raw entropy (150) flows to the Entropy Normalization and Assessment Engine (120), which processes this data through multiple stages of normalization, validation, and quality assessment. The resulting validated entropy (160) is then passed to the Output Stream Tokenizer (130), which transforms it into cryptographic key material and applies appropriate formatting for various cryptographic applications. Finally, the generated cryptographic keys (170) are transmitted to the Integration Layer (140), which provides interfaces for downstream security systems, identity frameworks, and cryptographic applications.

The architecture implements a unidirectional data flow model where each component performs specialized processing on the output of the previous stage. This approach enables high throughput while maintaining strict security boundaries between processing stages. The system operates as a cohesive pipeline, with each stage adding value to the entropy as it moves from raw collection to validated cryptographic keys, ultimately delivering quantum-grade entropy without requiring specialized quantum hardware.

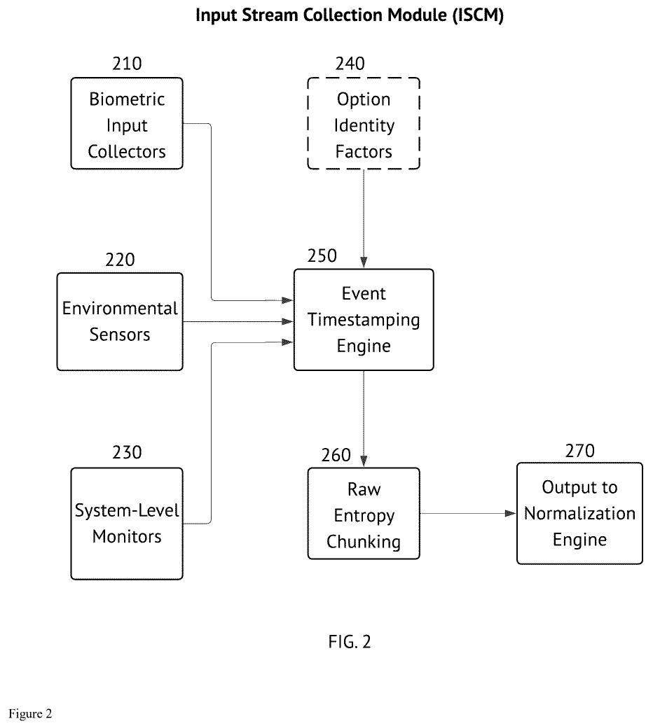

FIG. 2 provides a detailed illustration of the Input Stream Collection Module (ISCM) (110) and its constituent components. This module is responsible for gathering unpredictable data from diverse sources to create a rich entropy pool as described in paragraphs [0029] through [0038].

The Biometric Input Collectors (210) capture user interaction patterns including keystroke dynamics, mouse movements, and touch dynamics. These sources leverage the inherent unpredictability in human motor control systems to generate entropy with microsecond-level variations typically ranging from 30-300 ms. The Environmental Sensors (220) monitor various environmental parameters including temperature fluctuations, network timing variations, and ambient sensor data such as microphone background noise or camera sensor noise when such access is permitted. The System-Level Monitors (230) capture low-level system variations including CPU cycle differences, memory access pattern variations, and I/O timing fluctuations.

Optional Identity Factors (240) can be incorporated to personalize entropy generation, including behavioral patterns, location factors, and device signatures. This component is represented with a dashed border to indicate its optional nature within the system architecture.

The Event Timestamping Engine (250) applies microsecond-precision timestamps to all input events using a proprietary combination of system clock and CPU cycle information. This high-precision timing mechanism adds an additional layer of unpredictability to the collected data.

The Raw Entropy Chunking (260) component processes the timestamped data through a multi-stage hashing process that combines event data, timing information, and source identification. The chunked data is tagged with metadata including source identifier, timestamp, initial entropy estimate, collection context, and additional proprietary metadata elements.

The Output to Normalization Engine (270) component forwards the tagged raw entropy chunks to the Entropy Normalization and Assessment Engine for further processing. The architecture of the ISCM ensures that entropy is continually collected from multiple independent sources, creating a rich and diverse entropy pool that is resistant to compromise or prediction.

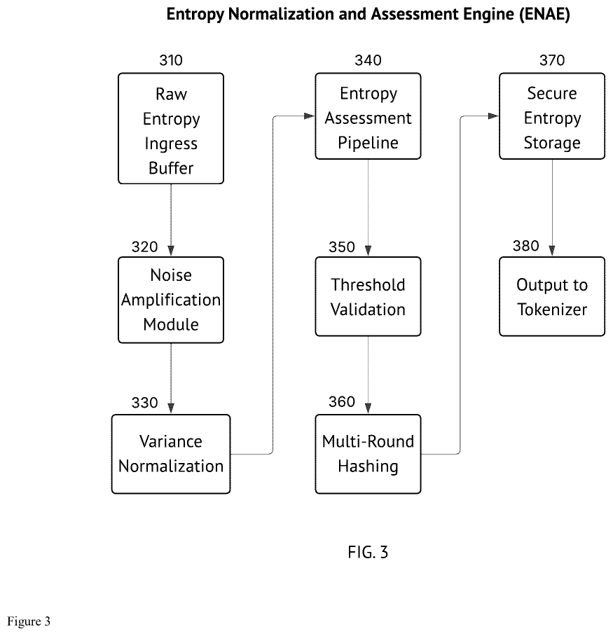

FIG. 3 details the Entropy Normalization and Assessment Engine (ENAE) (120), which transforms raw entropy chunks into validated, high-quality entropy blocks as described in paragraphs [0039] through [0049].

The Raw Entropy Ingress Buffer (310) serves as the entry point for raw entropy chunks from the ISCM, providing temporary storage and sequencing of incoming data. The Noise Amplification Module (320) enhances entropy through proprietary bitwise operations that increase bit-level unpredictability through transformation algorithms. This process combines original entropy with cryptographic transformations to enhance unpredictability.

The Variance Normalization (330) component standardizes value ranges across different entropy sources through proprietary statistical algorithms. This normalization ensures consistent statistical properties across heterogeneous input sources.

The Entropy Assessment Pipeline (340) represents the core quality validation mechanism, applying multiple complementary metrics to evaluate entropy quality through proprietary assessment methodologies. These metrics evaluate multiple aspects of randomness quality as described in the system's multi-metric assessment approach.

The Threshold Validation (350) component compares the calculated fitness scores against proprietary security thresholds determined through the system's adaptive threshold management. If thresholds are not met, additional entropy is requested from the ISCM.

For entropy that meets quality thresholds, the Multi-Round Hashing (360) component applies multiple cryptographic hash algorithms to further strengthen the entropy. This process includes a primary hash (SHA-512 or BLAKE2b), a secondary hash using a different algorithm, and time-seeded modular compression using proprietary techniques.

The Secure Entropy Storage (370) component temporarily stores validated entropy blocks with multiple security protections including memory encryption, anti-debugging measures, secure erasure after use, and side-channel attack mitigation as detailed in paragraph [0049].

Finally, the Output To Tokenizer (380) component transmits validated entropy blocks to the Output Stream Tokenizer for transformation into cryptographic keys. The ENAE implements a rigorous quality control process that ensures only high-quality entropy proceeds to the key generation stage, maintaining quantum-grade randomness throughout the system.

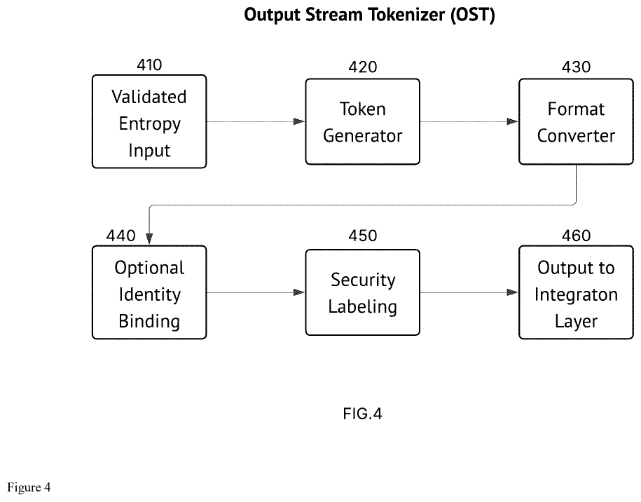

FIG. 4 illustrates the Output Stream Tokenizer (OST) (130), which transforms validated entropy blocks into cryptographic key material as described in paragraphs [0050] through [0056].

The Validated Entropy Input (410) component serves as the entry point for validated entropy blocks from the ENAE. The Token Generator (420) creates Entropy Stream Tokens (ESTs) using proprietary token generation algorithms that combine multiple elements through secure composition rules. These tokens serve as the foundation for various cryptographic key formats.

The Format Converter (430) transforms generic tokens into specific cryptographic key formats to support diverse application requirements. The supported formats include symmetric keys such as AES-256 and ChaCha20, asymmetric key pairs including RSA, ECC, and post-quantum algorithms, deterministic wallet seeds for cryptocurrency applications, and zero-knowledge proof parameters for privacy-preserving cryptographic protocols.

The Optional Identity Binding (440) component incorporates identity factors into the generated keys when this feature is enabled through proprietary binding methods that preserve both security and privacy. This binding creates keys that are cryptographically linked to user identity characteristics without exposing the underlying biometric data.

The Security Labeling (450) component adds metadata and classification information to the generated keys, facilitating appropriate handling and usage by downstream applications. This metadata can include intended use, security level classification, and validity parameters.

The Output to Integration Layer (460) component transmits the formatted cryptographic keys to the Integration Layer for distribution to security applications. The OST provides a flexible framework for converting raw entropy into application-specific cryptographic material, supporting a wide range of security protocols and requirements while maintaining the entropy quality achieved in earlier processing stages.

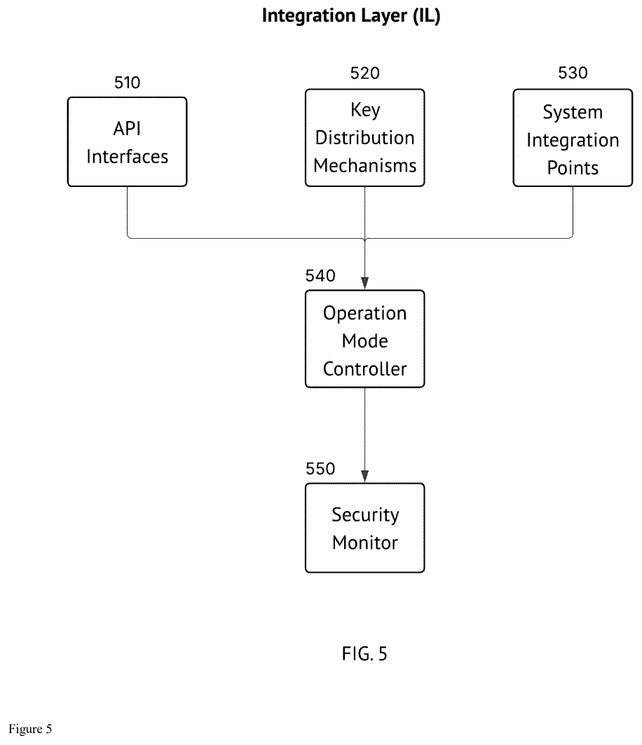

FIG. 5 details the Integration Layer (IL) (140), which provides interfaces between the SQEF system and downstream security applications as described in paragraphs [0054] through [0058].

The API Interfaces (510) component offers multiple integration mechanisms including a REST API for web applications, a native library for direct application integration, and a command-line interface for scripting and automation. These interfaces provide flexible access options for different deployment scenarios and application architectures.

The Key Distribution Mechanisms (520) component implements various protocols for securely delivering cryptographic keys to authorized recipients. These mechanisms include secure direct delivery for local applications, split-key protocols for high-security environments, threshold schemes for distributed authority, and key encapsulation mechanisms for secure transmission over potentially insecure channels.

The System Integration Points (530) component provides connectivity with existing security infrastructure including identity and access management systems, zero-trust architecture components, hardware security modules (HSMs), and secure enclaves such as Intel SGX or ARM TrustZone. These integration points allow the SQEF system to function within established security ecosystems.

The Operation Mode Controller (540) manages different operational modes including standard key generation for on-demand cryptographic keys, identity-bound token creation for keys linked to biometric or behavioral factors, continuous security validation for ongoing entropy assessment and key rotation, and emergency recovery for key regeneration in disaster recovery scenarios.

The Security Monitor (550) provides continuous oversight of the SQEF system's operation, detecting anomalies, ensuring compliance with security policies, and generating audit trails for security verification. This component works in coordination with the Operation Mode Controller to maintain system integrity under varying operational conditions.

The Integration Layer serves as the interface between the internal entropy generation mechanisms and external security applications, providing the flexibility, scalability, and security required for enterprise deployment while maintaining compatibility with existing security infrastructure.

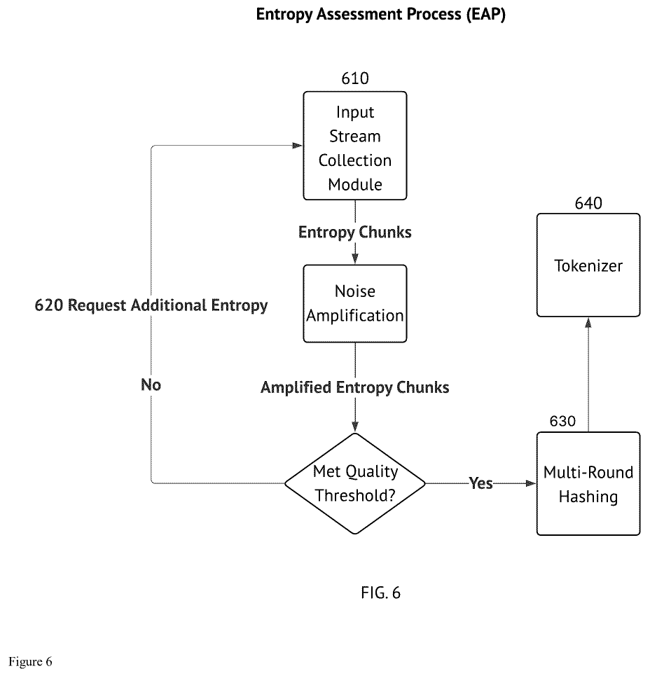

FIG. 6 presents a flowchart of the Entropy Assessment Process (EAP), detailing the decision points and data flows involved in validating entropy quality as described throughout paragraphs [0039] through [0049].

The process begins with raw entropy chunks received from the Input Stream Collection Module (610). These chunks undergo noise amplification through proprietary techniques to enhance their unpredictability.

After amplification, the system calculates multiple entropy quality metrics through proprietary assessment algorithms. These metrics evaluate various aspects of randomness quality and predictability resistance.

At decision point, the system evaluates whether the calculated metrics meet the quality thresholds determined by the system's security policy. If thresholds are not met, the process follows path to Request Additional Entropy (620) from the Input Stream Collection Module (610) and looping back to the beginning of the assessment.

If quality thresholds are met, the process follows path to apply Multi-Round Hashing (630), implementing proprietary hashing techniques. This includes primary and secondary hash applications using different algorithms and proprietary composition methods.

The validated and hashed entropy is then stored in secure memory with the protections outlined in paragraph [0049], including memory encryption, anti-debugging measures, secure erasure protocols, and side-channel attack mitigation.

Finally, the validated entropy blocks are output to the Tokenizer (640) component for conversion into cryptographic keys. This flowchart illustrates the rigorous assessment process that ensures only high-quality entropy proceeds to key generation, maintaining the quantum-grade randomness that distinguishes the SQEF system from conventional entropy sources.

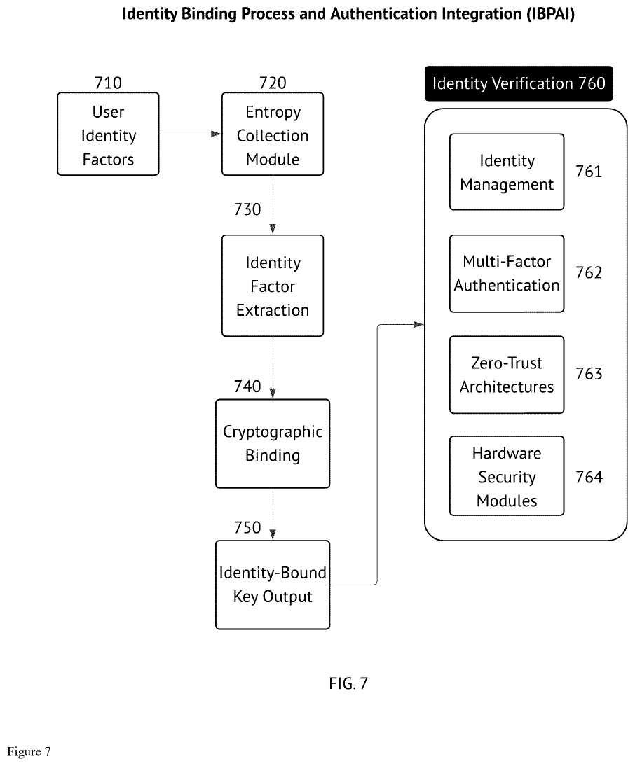

FIG. 7 details the Identity Binding Process and Authentication Integration (IBPAI) as described in paragraphs [0053] and [0068] through [0070].

The diagram illustrates the flow from User Identity Factors (710) through Entropy Collection Module (720), Identity Factor Extraction (730), and Cryptographic Binding (740) to produce Identity-Bound Key Output (750). The user identity factors include both biometric components such as fingerprints, facial features, and voice patterns, and behavioral components such as typing rhythms, gesture patterns, and usage habits.

The SQEF entropy collection component gathers these identity-specific patterns as part of its broader entropy collection process. The identity factor extraction component processes these characteristics through proprietary algorithms that preserve privacy while extracting distinguishing features. The cryptographic binding component uses proprietary methods to incorporate these features into the entropy used for key generation.

The identity-bound key output represents cryptographic material that requires both correct key material and matching identity factors for successful use. This enables additional security Identity Verification (760) features such as continuous passive authentication, hardware-independent identity verification, cryptographic key personalization, and key revocation through identity change.

The diagram also shows integration with authentication systems including Identity Management (761), Multi-Factor Authentication (762), Zero-Trust Architectures (763), and Hardware Security Modules (764). These integration points allow identity-bound keys to function within existing security ecosystems while providing enhanced verification capabilities.

The identity binding process enables cryptographic applications previously thought to require specialized hardware tokens, specifically the generation of keys that incorporate behavioral biometrics without requiring additional sensors beyond standard input devices. This capability addresses the “Lack of Identity Binding” limitation identified in paragraph [0007] and represents another significant advancement over prior art systems.

1. A method for generating cryptographic keys, comprising: (a) collecting entropy data from at least three distinct categories of entropy sources including biometric timing inputs, environmental randomness, and system-level jitter; (b) normalizing the collected entropy data across different source types; (c) performing multi-stage entropy quality assessment using at least Shannon entropy calculations and statistical deviation measurements; (d) filtering the normalized entropy to retain only high-entropy sequences based on adaptive threshold validation; (e) generating cryptographic key material from the validated high-entropy sequences; and (f) outputting the cryptographic key material in a format suitable for cryptographic applications.

2. The method of claim 1, wherein the biometric timing inputs comprise at least one of: keystroke dynamics, mouse movement patterns, and touch gesture timing.

3. The method of claim 1, wherein the environmental randomness comprises at least one of: temperature fluctuations, network timing variations, and ambient sensor data.

4. The method of claim 1, wherein the system-level jitter comprises at least one of: CPU cycle variations, memory access timing, and I/O operation timing.

5. The method of claim 1, wherein normalizing the collected entropy data comprises: a. timestamping all input events with microsecond precision; (b) applying noise amplification through bitwise operations; and (c) equalizing the value ranges across different entropy sources.

6. The method of claim 1, wherein performing multi-stage entropy quality assessment comprises: a. calculating Shannon entropy for each entropy block; (b) performing statistical tests including frequency analysis, runs tests, and serial correlation tests; (c) applying a weighted fitness function that combines multiple quality metrics; and (d) comparing the resulting fitness score against a predetermined threshold.

7. The method of claim 1, further comprising binding the cryptographic key material to identity factors through the incorporation of biometric or behavioral characteristics.

8. The method of claim 1, further comprising: a. storing validated entropy blocks in secure memory; (b) implementing memory encryption and anti-debugging measures; and (c) securely erasing entropy blocks after use.

9. The method of claim 1, wherein generating cryptographic key material comprises applying multi-round cryptographic hashing using at least two different hashing algorithms.

10. The method of claim 1, further comprising integrating the generated cryptographic key material with at least one of: zero-trust architectures, hardware security modules, secure enclaves, and identity management systems.

11. A system for generating high-entropy cryptographic keys without quantum hardware, comprising: a. an input stream collection module configured to gather entropy data from multiple heterogeneous sources; (b) an entropy normalization and assessment engine configured to process and validate entropy quality; (c) an output stream tokenizer configured to transform validated entropy into cryptographic keys; and (d) an integration layer configured to interface with downstream security systems.

12. The system of claim 11, wherein the input stream collection module gathers entropy from at least three of the following categories: biometric timing data, environmental sensor data, system-level jitter, and identity factors.

13. The system of claim 11, wherein the entropy normalization and assessment engine applies a multi-metric quality assessment including Shannon entropy calculations and statistical deviation measurements.

14. The system of claim 11, wherein the entropy normalization and assessment engine employs adaptive thresholds to filter entropy sequences based on their fitness scores.

15. The system of claim 11, wherein the output stream tokenizer supports multiple key formats including symmetric keys, asymmetric key pairs, and application-specific tokens.

16. The system of claim 11, wherein the integration layer provides multiple interface options including REST API, native library, and command-line interface.

17. The system of claim 11, wherein the system operates as a background service with a memory footprint of less than 20 MB and average CPU utilization of less than 2%.

18. The system of claim 11, wherein the system implements security measures to protect entropy data including memory encryption, anti-debugging features, and secure erasure after use.

19. A non-transitory computer-readable medium storing instructions that, when executed by a processor, cause the processor to perform a method for generating cryptographic keys, the method comprising the steps of claim 1.

20. A method for binding cryptographic keys to identity factors, comprising: (a) collecting entropy data according to the method of claim 1; (b) capturing user-specific behavioral or biometric characteristics; (c) incorporating the characteristics into the entropy assessment process; and (d) generating identity-bound cryptographic keys that require both the correct key material and matching identity factors for successful use.

21. A method for generating post-quantum cryptographic keys using conventional computing hardware, comprising: a. collecting entropy data from multiple heterogeneous sources including at least biometric timing inputs and system-level jitter; (b) applying a multi-stage entropy assessment process to validate entropy quality; (c) generating key material with entropy levels exceeding 7.95 bits per byte; and (d) formatting the key material for use with post-quantum cryptographic algorithms.

22. The method of claim 21, wherein the post-quantum cryptographic algorithms include at least one of: lattice-based cryptography, hash-based cryptography, code-based cryptography, and multivariate cryptography.

23. A method for implementing the system of claim 11 on mobile devices, comprising: a. optimizing the input stream collection module to prioritize mobile-specific sensors including touch dynamics, device motion, and ambient environmental data; (b) implementing battery-efficient processing algorithms for entropy assessment; (c) providing integration with mobile security frameworks; and (d) generating cryptographic keys with entropy levels comparable to hardware-based generators while maintaining average CPU utilization below 1%.

24. A method for implementing the system of claim 11 on server environments, comprising: a. configuring the input stream collection module to gather entropy from virtualized environments; (b) implementing distributed entropy collection across multiple server instances; (c) providing high-throughput key generation exceeding 1000 keys per second; and (d) integrating with server-based security infrastructure including hardware security modules and key management systems.

25. A method for continuous entropy quality validation, comprising: a. collecting entropy data according to the method of claim 1; (b) implementing real-time monitoring of entropy source quality; (c) dynamically adjusting source weighting based on measured entropy contribution; and (d) alerting system administrators when entropy quality falls below predetermined thresholds.

26. A method for providing cryptographic key generation as a service using the system of claim 11, comprising: (a) deploying the system on a service provider infrastructure with multi-tenant architecture that isolates entropy pools between different client organizations; (b) receiving requests for cryptographic key generation from client applications via a secure API; (c) executing the entropy collection and validation process on server-side infrastructure; (d) delivering the generated cryptographic keys to the requesting clients through encrypted channels; (e) maintaining an audit trail of key generation activities while protecting the confidentiality of the keys themselves; (f) providing configurable security policies that allow clients to specify entropy quality thresholds, key formats, and delivery mechanisms; and (g) supporting integration with third-party security services through standardized interfaces and certificate-based authentication.

27. A method for implementing the system of claim 11 on mobile and resource-constrained devices, comprising: (a) optimizing the input stream collection module for device-specific sensors including touch dynamics, accelerometer data, gyroscope readings, device motion, and ambient environmental data; (b) implementing power-efficient processing algorithms with adjustable entropy source selection based on available device sensors and power conditions; (c) providing secure API interfaces that allow applications to request and receive cryptographic key material; (d) implementing local caching of validated entropy blocks for offline operation; (e) establishing a hierarchical entropy collection architecture where gateway devices supplement entropy collection for more constrained endpoint devices; and (f) providing fallback modes that maintain minimum security thresholds when devices operate in energy conservation states.

28. A method for adapting the system of claim 11 for specialized application domains, comprising: (a) generating domain-specific cryptographic material including wallet seed phrases for blockchain applications, transaction authentication keys for financial services, and high-security tokens for government and military systems; (b) implementing compliance mechanisms appropriate to the domain including regulatory-compliant audit logs, provable entropy quality attestations for distributed consensus, and multi-level security classifications; (c) providing domain-specific integration interfaces including distributed ledger connectivity, financial transaction processing systems, and air-gapped high-security environments; and (d) establishing domain-appropriate security measures including physical isolation mechanisms, hardware-attested secure boot processes, and fraud detection based on entropy source anomalies.

29. A method for deploying and maintaining the system of claim 11 in enterprise environments, comprising: (a) providing a deployment package that installs the system components with appropriate configuration for the client environment; (b) implementing non-disruptive integration with existing cryptographic infrastructure including key management systems, hardware security modules, and certificate authorities; (c) supporting hybrid operational modes that combine the system's entropy with existing entropy sources according to configurable policies; (d) establishing secure monitoring capabilities for system health and entropy quality; and (e) enabling migration paths from traditional to post-quantum cryptographic implementations while maintaining consistent entropy quality.

30. A method for enhancing the security resilience of the system of claim 11, comprising: (a) implementing multi-party computation protocols for distributed key custody; (b) providing cryptographic proofs that verify the incorporation of system-generated entropy in downstream operations; (c) supporting key recovery mechanisms compatible with distributed governance models; (d) enabling zero-knowledge proofs of entropy quality without revealing the actual entropy data; and (e) implementing device-binding mechanisms that incorporate hardware-specific characteristics into the entropy assessment process.

31. A software-only method for generating quantum-grade entropy without specialized hardware, comprising: (a) collecting entropy data exclusively from software-accessible sources including user interaction patterns, system operation metrics, and environmental variations; (b) applying multi-stage entropy fusion to combine these sources into a unified high-quality entropy pool; (c) implementing real-time entropy quality assessment through Shannon entropy calculations and statistical analysis; and (d) generating cryptographic keys with entropy levels exceeding 7.95 bits per byte without requiring quantum hardware or specialized entropy generation devices.

32. A method for incorporating behavioral and biometric inputs into entropy generation, comprising: (a) capturing fine-grained timing patterns from user interactions including keystroke dynamics, mouse movements, and touch gestures; (b) extracting entropy from these behavioral patterns while preserving user privacy; (c) applying statistical normalization to ensure consistent entropy quality across different users and interaction patterns; and (d) combining behavioral entropy with system-level entropy sources to enhance overall randomness quality.

33. A method for identity-bound entropy fusion, comprising: (a) capturing user-specific behavioral and biometric characteristics during normal system operation; (b) deriving distinguishing features that uniquely identify the user without storing raw biometric data; (c) cryptographically binding these identity features to generated entropy pools; (d) producing cryptographic keys that are intrinsically linked to user identity; and (e) enabling authentication through the verification of both key material and identity factors.

34. A method for real-time entropy quality assessment and adaptive control, comprising: (a) continuously monitoring multiple metrics of entropy quality including Shannon entropy, min-entropy, and statistical distribution properties; (b) dynamically adjusting source weighting based on real-time quality assessment; (c) detecting and mitigating entropy source degradation or compromise; (d) maintaining audit logs of entropy quality metrics; and (e) providing feedback mechanisms to optimize entropy collection strategies.

35. A compliance-aware entropy generation method, comprising: (a) implementing entropy assessment algorithms that align with NIST SP 800-90B guidelines; (b) maintaining comprehensive audit records of entropy source quality; (c) providing attestation mechanisms that verify entropy quality without exposing raw entropy data; (d) supporting regulatory compliance verification for cryptographic operations; and (e) enabling third-party validation of entropy quality without compromising system security.

36. A method for implementing a cryptographic framework resistant to quantum computing attacks without quantum hardware, comprising: (a) generating high-entropy cryptographic keys using the method of claim 31; (b) supporting cryptographic algorithms designed to withstand quantum computing attacks, including lattice-based cryptography, hash-based cryptography, code-based cryptography, and multivariate cryptographic schemes; (c) providing entropy quality levels meeting or exceeding the minimum security strength requirements specified by NIST for post-quantum cryptographic applications; and (d) enabling transition mechanisms from conventional cryptographic implementations to quantum-attack-resistant implementations while maintaining consistent entropy quality throughout the migration process.
